(19) United States
(12) Patent Application Publication
(10) Pub. No.: US 2015/0067041 A1
(43) Pub. Date: Mar. 5, 2015

(54) INFORMATION SERVICES FOR REAL WORLD AUGMENTATION

(71) Applicant: Intel Corporation, Santa Clara, CA (US)

(72) Inventor: Kumar C. Gopalakrishnan, Mountain View, CA (US)

(21) Appl. No.: 14/538,544

(22) Filed: Nov. 11, 2014

Related U.S. Application Data
(63) Continuation of application No. 11/423,252, filed on Jun. 9, 2006, now abandoned.
Application No. 11/423,252 is a continuation-in-part of application No. 11/215,601, filed on Aug. 30, 2005, now abandoned.
(60) Provisional application No. 60/689,345, filed on Jun. 10, 2005.
(60) Provisional application No. 60/689,613, filed on Jun. 10, 2005.
(60) Provisional application No. 60/689,618, filed on Jun. 10, 2005.
(60) Provisional application No. 60/689,741, filed on Jun. 10, 2005.
(60) Provisional application No. 60/689,743, filed on Jun. 10, 2005.
(60) Provisional application No. 60/606,282, filed on Aug. 31, 2004.

(51) Int. Cl. H04L 29/06; G06F 17/30

(52) U.S. Cl. CPC H04L 67/42; G06F 17/30964
USPC 709/203; 707/736

(57) ABSTRACT

A method and system provides information services for augmentation of real world environments. The information services include features for retrieving and presenting information, authoring new information services, authoring new information services, storing information, storing information services, communicating information, communicating information services, sharing information, sharing information services, executing e-commerce transactions and authenticating identification tokens.

### CROSS-REFERENCE TO RELATED APPLICATIONS

This application claims the benefit of U.S. provisional patent applications 60/689,345, 60/689,613, 60/689,618, 60/689,741, and 60/689,743, all filed Jun. 10, 2005, and is a continuation in part of U.S. patent application Ser. No. 11/215,601, filed Aug. 30, 2005, which claims the benefit of U.S. provisional patent application 60/606,282, filed Aug. 31, 2004. These applications are incorporated by reference along with any references cited in this application.

### BACKGROUND OF THE INVENTION

The present invention is related to providing information services on a computer system. More specifically, the invention is related to information services that augment a real-world environment.

Augmented reality systems that can provide an overlay of computer-generated information on real world environments have been demonstrated. However, at present, such technologies are not suitable for mass-market commercial offering. A commercial offering for augmenting real world environments with information services requires a system that automatically provides a plurality of information services without extensive changes to the real world environment.

### BRIEF SUMMARY OF THE INVENTION

The present invention enables a user to perceive an augmented representation of the real world environment by providing information services that enhance the real-world environment, components of the real world environment and the user's activity in the real-world environment. The information services are identified and provided based on multimodal contexts. The multimodal contexts are generated from multimodal inputs such as multimedia content, associated metadata, user inputs, and knowledge sourced from knowledge bases.

Features of the information services include providing information relevant to the real world environment, enabling commercial transactions derived from the real-world environment, enabling the association of information and services with the real-world environment, offering a platform for authentication and security for components of the real-world environment, storage of multimodal information related to the real-world environment, communication of multimodal information related to the real-world environment, and enabling the sharing of multimodal information related to the real-world environment between users.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 illustrates an exemplary system, in accordance with an embodiment.

FIG. 2 illustrates an alternate view of an exemplary system, in accordance with an embodiment.

FIG. 3 illustrates an exemplary process for providing information services related to multimodal contexts in passive augmentation mode.

FIG. 4 illustrates an exemplary process for providing information services related to multimodal contexts in active augmentation mode.

FIG. 5(a) illustrates an exemplary presentation of information services independent of the multimodal inputs, in accordance with an embodiment.

FIG. 5(b) illustrates an exemplary presentation of information services with augmentation of the multimodal inputs, in accordance with an embodiment.

FIG. 6(a) illustrates an exemplary presentation of information services with intrinsic augmentation of the multimodal inputs, in accordance with an embodiment.

FIG. 6(b) illustrates an exemplary presentation of information services with extrinsic augmentation of the multimodal inputs, in accordance with an embodiment.

FIG. 7 illustrates an exemplary process for providing information services that retrieve and present information related to multimodal contexts.

FIG. 8 illustrates an exemplary process for providing e-commerce services related to multimodal contexts.

FIG. 9 illustrates an alternate exemplary process for providing information services related to multimodal contexts with embedded e-commerce features.

FIG. 10 illustrates an exemplary process for providing authentication information services related to multimodal contexts.

FIG. 11 illustrates an exemplary process for authoring new information and associating it with a multimodal context.

FIG. 12 illustrates an exemplary process for using storage features of information services related to multimodal contexts.

FIG. 13 illustrates an exemplary process for using communication features of information services related to multimodal contexts.

FIG. 14 illustrates an exemplary process for using sharing information services among users of the system.

FIG. 15 illustrates an exemplary process for using an information service related to a multimodal entertainment context.

### DETAILED DESCRIPTION OF THE INVENTION

Various embodiments may be implemented in numerous ways, including as a system, a process, an apparatus, or a series of program instructions on a computer readable medium such as a computer readable storage medium or a computer network where the program instructions are sent over optical, electrical, electronic, or electromagnetic communication links. In general, the steps of disclosed processes may be performed in an arbitrary order, unless otherwise provided in the claims.

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

Reference in the specification to “one embodiment” or “an embodiment” or “some embodiments” means that a particular feature, structure, or characteristic described in connection with the embodiment is included in at least one embodiment of the invention. The appearances of the phrase “in one embodiment” or “in some embodiments” in various places in the specification are not necessarily all referring to the same embodiment, nor are separate or alternative embodiments mutually exclusive of other embodiments. Features and aspects of various embodiments may be integrated into other embodiments, and embodiments illustrated in this document may be implemented without all of the features or aspects illustrated or described.

Various embodiments presented enable a user to perceive an augmented representation of a real world environment by providing information services relevant to the real world environment, components of the real world environment and the user's activity in the real world environment. In the scope of this document, the physical world environment in which a user is using such embodiments is referred to as the “real world” to distinguish it from the abstract world of information sources or information collections, i.e., the “cyber world.” In the scope of this document, the term “system” may generally refer to a mechanism that offers the information services described here.

The term “information service” refers to a user experience provided by the system that may include (1) the logic to present the user experience, (2) multimedia content, and (3) related user interfaces. The three components of the information service are distributed over the various components of the system implementing the information service in some embodiments. For instance, in a client-server architecture, the logic to present the user experience may be split between the client and server, the related user interface implemented on the client and the multimedia data present both at the client and server. The terms “content” or “information” is used to refer to multimedia data used in the information services.

The system, in various embodiments, uses a set of one or more multimodal inputs from the real world environment, to identify and provide related information services. Visual information that is part of the multimodal input could be in the form of a single still image, a plurality of related or unrelated still images, a single video sequence, a plurality of related or unrelated video sequences or a combination thereof. The system generates a list of zero or more information services that are determined to be relevant to the multimodal inputs. The list of relevant information services may be presented to a user in a standalone representation independent of the multimodal input information or in a layout that enables the information services to augment the multimodal input information in an intrinsic and intuitive manner.

Providing of the information services offered by various embodiments may be accompanied by financial transactions. Providers of the information used in the information services, providers of the constituents of the contexts with which information services are associated, authors of the information services and operators of the system may optionally be financially compensated as part of the financial transaction. Based on the nature of the financial transaction, the information services may be classified as commercial, sponsored, or regular information services.

Information services for which the consumer of the information services pays for using the information service are termed commercial information services. Information services for which the producer of the information services pays the operators of the system for providing the information service to the consumer are termed sponsored information services. Information services that are not provided under the commercial information service or sponsored information service models are termed regular information services. Regular information services may be provided without any accompanying financial transactions or under other business models as determined by the operators of the system. In some embodiments, information services may also incorporate elements of sponsored, commercial and regular information services. For example, one part of an information service may be provided free of cost while, another part may require the user to a pay the operators a fee.

System Architecture

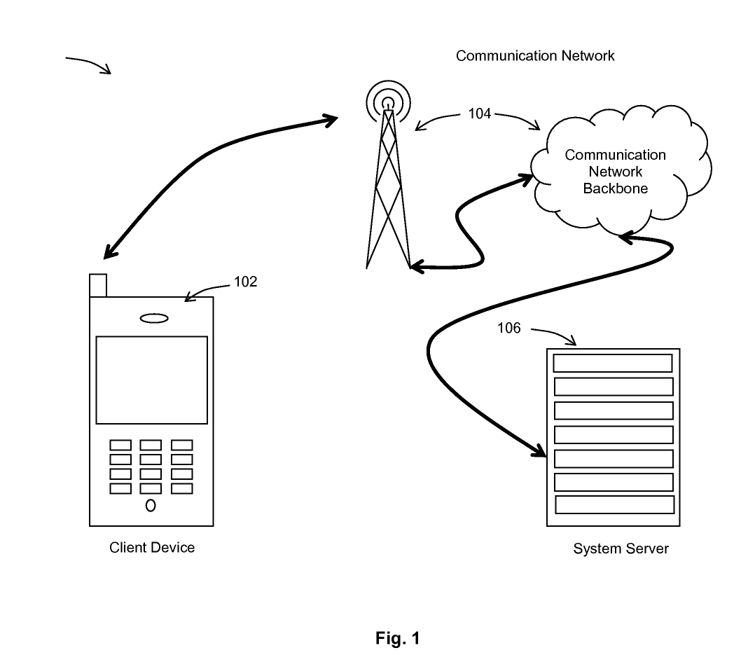

FIG. 1 illustrates an exemplary system, in accordance with an embodiment. Here, system 100 includes client device 102, communication network 104, and system server 106.

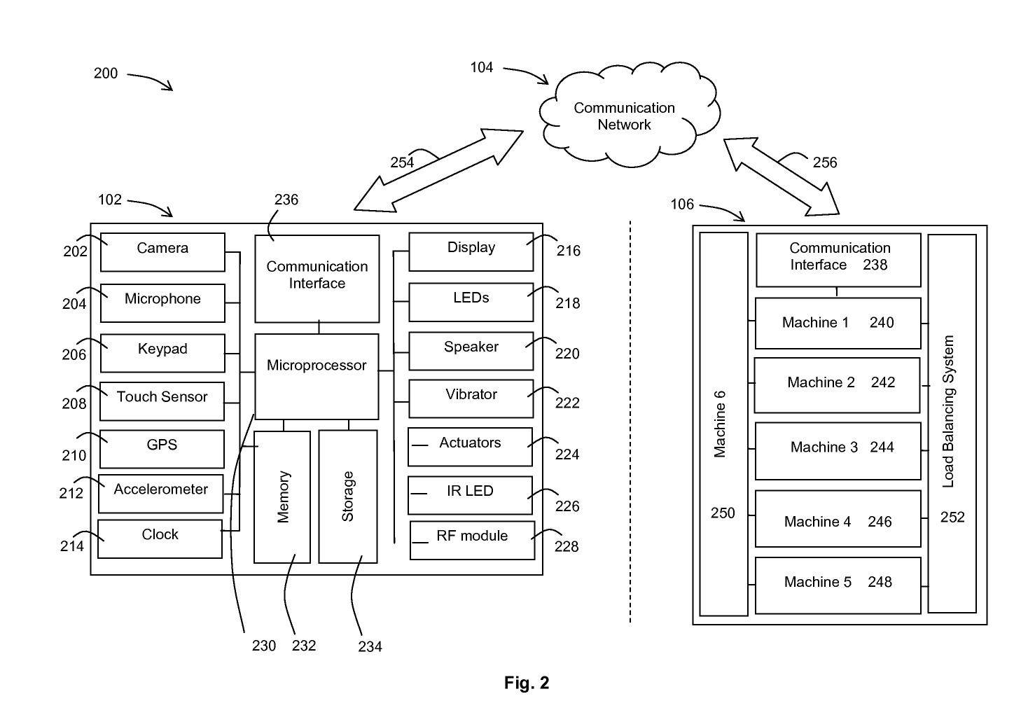

FIG. 2 illustrates an alternative view of an exemplary system, in accordance with an embodiment. System 200 illustrates the hardware components of the exemplary embodiment (e.g., client device 102, communication network 104, and system server 106). Here, client device 102 communicates with system server 106 over communication network 104. In some embodiments, client device 102 may include camera 202, microphone 204, keypad 206, touch sensor 208, global positioning system (GPS) module 210, accelerometer 212, clock 214, display 216, visual indicators (e.g., LEDs) and/or a projective display (e.g., laser projection display systems) 218, speaker 220, vibrator 222, actuators 224, IR LED 226, Radio Frequency (RF) module (i.e., for RF sensing and transmission) 228, microprocessor 230, memory 232, storage 234, and communication interface 236. System server 106 may include communication interface 238, machines 240-250, and load balancing subsystem 252. Data flows 254-256 are transferred between client device 102 and system server 106 through communication network 104. Communication network 104 includes a wireless network such as GPRS, UMTS, 802.16x, 802.11x, 1X, EV-DO and the like.

Client device 102 includes camera 202, which is comprised of a visual sensor and appropriate optical components. The visual sensor may be implemented using a Charge Coupled Device (CCD), a Complementary Metal Oxide Semiconductor (CMOS) image sensor or other devices that provide similar functionality. The camera 202 is also equipped with appropriate optical components to enable the capture of visual content. Optical components such as lenses may be used to implement features such as zoom, variable focus, macro mode, auto focus, and aberration-compensation. Client device 102 may also include a visual output component (e.g., LCD panel display) 216, visual indicators (e.g., LEDs) and/or a projective display (e.g., laser projection display systems) 218, audio output components (e.g., speaker 220), audio input components (e.g., microphone 204), tactile input components (e.g., keypad 206, keyboard (not shown), touch sensor 208, and others), tactile output components (e.g., vibrator 222, mechanical actuators 224, and others) and environmental control components (e.g., Infrared LED 226, Radio-Frequency (RF) transceiver 228, vibrator 222, actuators 224). Client device 102 may also include location measurement components (e.g., GPS receiver 210), spatial orientation and motion measurement components (e.g., accelerometers 212, gyroscope), and time measurement components (e.g., clock 214).

Examples of client device 102 include communication equipment (e.g., cellular telephones), business productivity gadgets (e.g., Personal Digital Assistants (PDA)), consumer electronics devices (e.g., digital camera and portable game devices or television remote control). In some embodiments, components, features, and functionality of client device 102 may be integrated into a single physical object or device such as a camera phone. In such embodiments, communication network 104 may be realized as a computer bus (e.g., PCI) or a cable connection (e.g., Firewire).

In some embodiments, client device 102 is a single physical device (e.g., a wireless camera phone). In some embodiments, client device 102 may be implemented in a distributed configuration across multiple physical devices. In such embodiments, the components of client device 102 described above may be integrated with other physical devices that are not part of client device 102. Examples of physical devices into which components of client device 102 may be integrated include cellular phone, digital camera, Point-of-Sale (POS) terminal, webcam, PC keyboard, television set, computer monitor, and the like. Components (i.e., physical, logical, and virtual components and processes) of client device 102 distributed across multiple physical devices are configured to use wired or wireless communication connections among them to work in a unified manner.

In some embodiments, client device 102 may be implemented with a personal mobile gateway for connection to a wireless Wide Area Network (WAN), a digital camera for capturing visual content and a cellular phone for control and display of documents and information service with these components communicating with each other over a wireless Personal Area Network such as Bluetooth™ or a LAN technology such as Wi-Fi (i.e., IEEE 802.11x). In some embodiments, components of client device 102 are integrated into a television remote control or cellular phone while a television is used as the visual output device.

In some embodiments, a collection of wearable computing components, sensors and output devices (e.g., display equipped eye glasses, direct scan retinal displays, sensor equipped gloves, and the like) communicating with each other and to a long distance radio communication transceiver over a wireless communication network constitutes client device 102. In some embodiments, projective display 218 projects the visual information to be presented on to the environment and surrounding objects using light sources (e.g., lasers), instead of displaying it on display panel 216 integrated into the client device.

While the visual components of the user interface are presented through display 216, audio components of the user interface may be presented through speaker 220 integrated into client device 002 while the integrated camera 202, microphone 204 and keypad 206 act as the input sources for visual, audio and textual information. The client logic by itself may be implemented as software executing on microprocessor 230 or using equivalent firmware or hardware.

Operation

Information services are associated with visual imagery through interpretation of context constituents associated with the visual imagery. Context constituents associated with visual imagery may include: 1) embedded visual elements derived from the visual imagery, 2) metadata and user inputs associated with the visual imagery, and 3) relevant knowledge derived from knowledge bases.

The association of information services to contexts may be done manually or automatically by system 100. In some embodiments, system 100 generates contexts from context constituents associated with visual imagery and provides relevant information services through an automated process. The generation of a plurality of contexts, each of which may have a varying degree of relevance to the visual imagery, and the association of information services of varying degree of relevance to the contexts, provide aggregated sets of information services ranked by their relevance to the visual imagery.

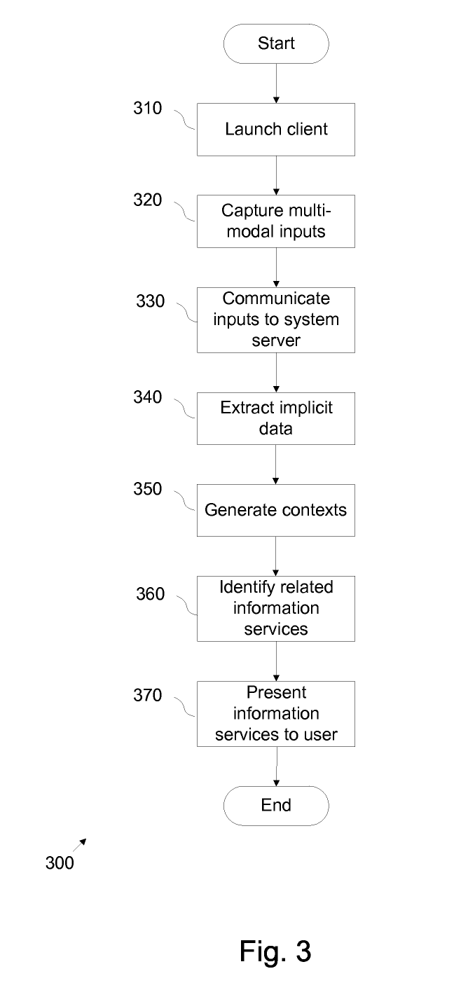

FIG. 3 illustrates an exemplary process 300 for using an information service provided by the system. Process 300 and other processes of this document are implemented as a set of modules, which may be process modules or operations, software modules with associated functions or effects, hardware modules designed to fulfill the process operations, or some combination of the various types of modules. The modules of process 300 and other processes described herein may be rearranged, such as in a parallel or serial fashion, and may be reordered, combined, or subdivided in various embodiments.

A user launches 310 the client software application in client device 102 using methods appropriate for the client device environment such as selecting and launching the client application from a menu of applications available in the client device. In some embodiments of the system, employing a passive augmentation mode of operation, the user captures visual imagery 320 in the form of a single still image, a plurality of still images, a single video sequence, a plurality of video sequences or a combination thereof of his real world environment by activating one or more input components on client device 102. In addition to the visual imagery, the client may also capture other primary data and metadata.

The client then communicates 330 the captured visual imagery, associated primary data and metadata to system server 106. System server 106 analyses the captured visual imagery, associated primary data and metadata using appropriate analysis tools 340 to extract embedded implicit data. For instance, the textual information and its formatting, e.g., the font used, the color of the text and its background and the relative position of the characters of the text relative to each other and relative to the boundaries of the visual imagery, are extracted using a text recognition engine.

Specialized visual recognition engines identify and recognize other objects present in the visual imagery. Such extracted implicit data is used in association with the primary data and metadata to construct a plurality of contexts which are ranked based on their intrinsic relevance to the multimodal input information generated by the client 350. A shortlist of the most relevant contexts is then used to query content databases both internal and external to the system to generate a ranked list of relevant information services 360. The generated list of information services is then presented to the user on the client 370. The final list presented to the user may contain zero or more information services as determined by system 100.

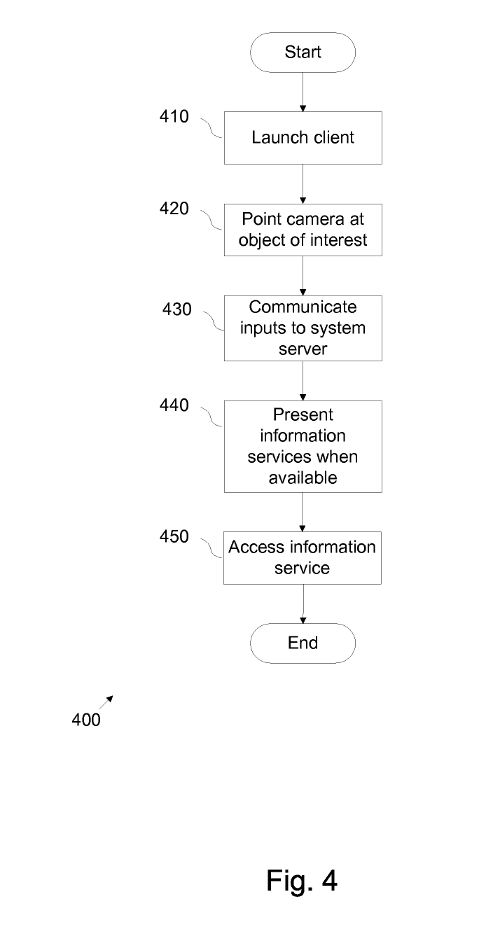

In some embodiments of the system, employing an active augmentation mode of operation, presentation of information services on the client is activated by just pointing the camera 202 integrated into the client device 102 at a real world scene, without explicit inputs by the user on the client user interface. FIG. 4 illustrates an exemplary process 400 for the active augmentation mode of operation. The user launches the client software application his client device 410. He then points the camera 202 integrated into client device 102 at a series of storefronts in a mall 420.

The client automatically captures images or video sequences based on criteria determined by the system 100 without explicit instruction from the user and processes them 430. Whenever the system identifies the availability of information services associated with a particular store, the client alerts the user 440. The alert may be in a visual form such as change in color or other graphical marks overlaid on the live visual reference information, in audio form such as a beep or a combination thereof. The user can then choose to access the available information services 450.

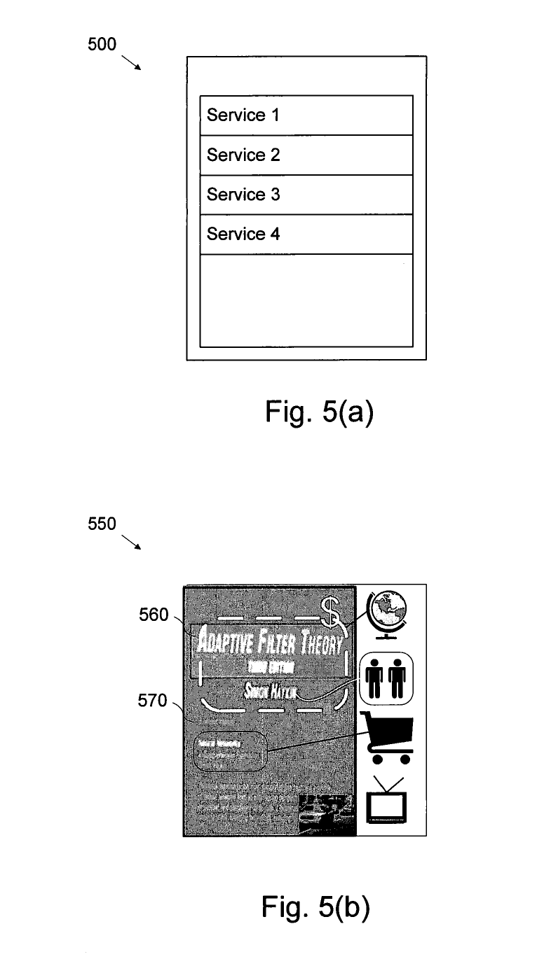

In some embodiments of the system, the list of relevant information services is presented as a linear or sequential list of information service options. In other embodiments of the system, the list of relevant information services is presented such that the entries in the list of relevant information service options are integrated with the multimodal input information to present an intuitive augmentation of the multimodal input information. FIG. 5(a) illustrates an example of presentation of information services 500 independent of the multimodal inputs. FIG. 5(b) illustrates an example of presentation of information services 550 as an intrinsic augmentation of the captured visual imagery input. The availability of an information service related to the visual imagery is represented by dashed line cursor 560 augmenting the visual imagery 570 in viewfinder.

While the above description provides the common operational flow for an embodiment of a system, specific features of exemplary information services and their unique usage and behavior follows. Various features of embodiments of exemplary information services presented may be integrated into an information service. Information services may offer exclusively one of the features or integrate a plurality of the features, as required.

In some embodiments, information services present information relevant to the multimodal contexts. The relevant information may be aggregated from a plurality of sources such as World Wide Web content, listings of World Wide Web content provided by Web search engines, domain specific knowledge bases such as a dictionary, thesaurus, encyclopedias or other such domain specific information reference sources and information such as weather, news, stock quotes and product and service information such as pricing and reviews of the products and services. In addition, relevant information may also be sourced from the user's personal computing or storage equipment such as a personal computer. Information may be aggregated from various sources using proprietary or standard protocols/formats such as Web services, XML, RSS, Atom, etc.

The presented relevant information may be in audio, video, graphical, or textual media formats. Depending on the specification of an information service, the information embedded in the information service may be presented in its native media format or transformed into a different media format. An example of using relevant information to augment multimodal input information of corresponding media type is where the visual input information captured by the camera 202 built into system 100 is overlaid with graphical information such as icons and cartoons that are sourced from the relevant information. Depending on the specification of an information service, the information embedded in the information service may be presented as a stand alone entity or in conjunction with multimodal input information. An example of using relevant information to augment multimodal input information of a different media type is where the visual input information captured by a camera built into a system is overlaid with textual information generated from relevant information in audio format using a speech recognition module.

The augmentation of the multimodal input information with the relevant information is either intrinsic or extrinsic. Intrinsic augmentation refers to the embedding of the relevant information such as to make it indistinguishable from the multimodal input information. Extrinsic augmentation refers to the integration of the relevant information such that it is possible to distinguish the augmentation information from the multimodal input information.

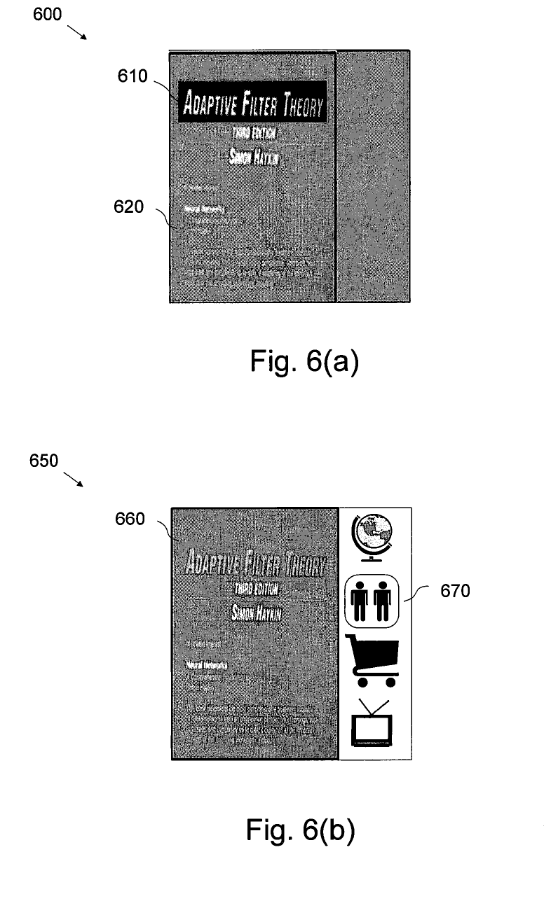

An example of intrinsic augmentation is the addition of a realistically rendered three-dimensional graphic of a ball rendered using polygon based graphic synthesis or Image Based Rendering to a scene of soccer players on the field. The intrinsic augmentation makes the ball used to augment the image of the soccer players indistinguishable from the rest of the image. Another example of intrinsic augmentation is to visually augment the image of the cover of a book with graphics in the form of “cartoon balloons” overlaid on the imagery of the book with description and pricing information. FIG. 6(a) illustrates such an augmentation 600 where highlighted link 610 is embedded in the visual imagery 620.

In extrinsic augmentation, the augmentation information is obviously distinct from the multimodal input and is used to convey the external nature of the augmentation information. An example of extrinsic augmentation is the use of simple text and icons on top of visual imagery. FIG. 6(b) illustrates such an augmentation 650 where icons 670 are distinct from the visual imagery 660.

The augmentation information thus presented is either self-contained such that it conveys the complete information to be communicated to the user or hyperlinked to other information. When hyperlinked to other information, the user may be able to traverse the hyperlinks to retrieve the additional information.

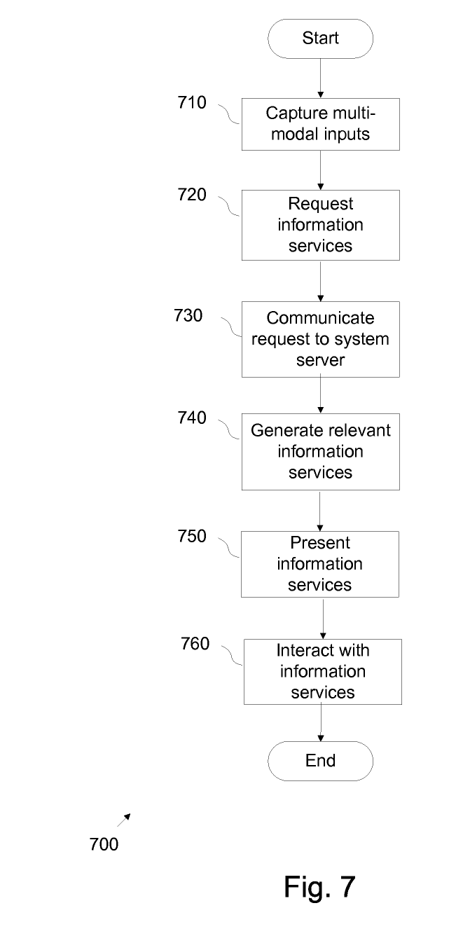

FIG. 7 illustrates an exemplary sequence of operations for process 700 for using an information service for retrieving information relevant to visual imagery. The process begins with the user capturing visual imagery from his real world environment using the camera 202 view of the client user interface 710. In this example, the captured visual imagery is a sequence of still images of a book beginning with an image of the book's cover followed by images of text inside the book for which the user intends to request associated information services.

The client user interface provides appropriate controls for controlling the camera 202 built into the client device 102 and for capturing the visual imagery and related metadata such as the time and location of the user. The user then requests the system to provide information services associated with the captured visual imagery by selecting the appropriate commands from a menu or clicking on a button on the user interface 720. The client encodes the captured information and communicates it to the system server 730.

The system server decodes and analyses the information received from the client and generates a list of relevant information relevant to the captured visual imagery of the book 740. The list of relevant information is then communicated to the client and presented on the client user interface 750. The user then browses through the available set of information and selects say a book price information options for further presentation 760. In some embodiments, the geo-spatial location collected from the client as metadata may be used to present a map of nearby bookstores selling the book.

The information provided from various sources may also be used to drive off-line services or physical systems. An exemplary off-line service driven by an information service is the mailing of a product or coupon. An exemplary physical system driven by an information service is control of a robot.

In some embodiments, the information services may include e-commerce features. The e-commerce features may be the primary function of the information services or the e-commerce features may be present along with other features in an information service.

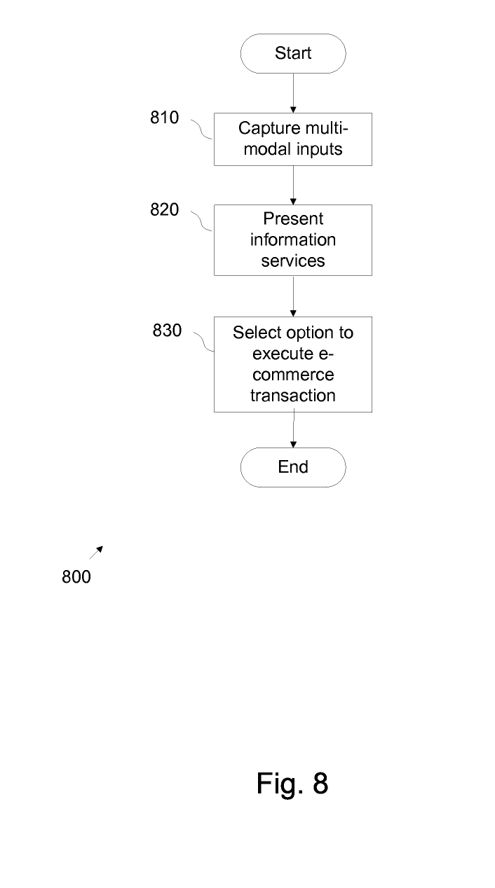

FIG. 8 illustrates an exemplary sequence of operations for process 800 of using an information service created solely for e-commerce. The user captures visual imagery of a product such as a book 810. The title and graphical layout of the book's cover art are used by system 100 to obtain a list of products relevant to the book which the user can then select from 820. The system then provides the user with an option to purchase the selected product and have it delivered either electronically in case of an electronic product such as an e-book or physically in case of a physical product such as a paper book 830. The financial information for completing the transaction is entered into the system as part of the user's interaction with the information service 840, for example, by typing in a credit card number. In some embodiments, the system may also store the user's financial information as part of the user's account information and automatically use it to complete the financial transaction or obtain the financial information from other third party sources.

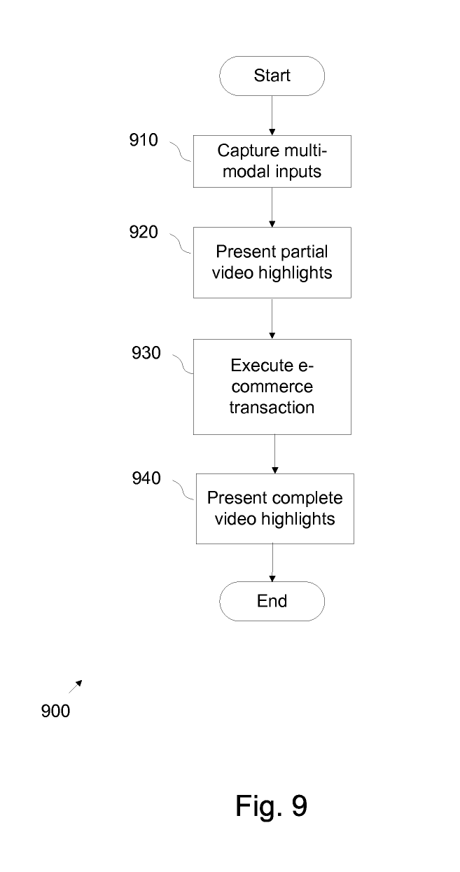

Besides information services created solely for the purpose of executing an e-commerce transaction, information services that belong to the other classes of information services illustrated in this description may also embed e-commerce features. FIG. 9 illustrates the exemplary sequence of operations for process 900 of using an information service that embeds an e-commerce functionality. A user using an information service captures visual imagery of a scorecard from a baseball game published in a newspaper 910.

The information service then retrieves and presents video highlights of the key action scenes from the game 920. The video sequence presented may use video segmentation schemes to separately encode the ball and the rest of the scene. Then, the ball is hidden in the video sequence unless the user pays for access to the complete video sequence by completing an e-commerce transaction embedded in the information service. The user then completes the e-commerce transaction 930 to have the complete video sequence including the ball presented to him 940.

Another example of an information service with an embedded e-commerce transaction involves the presentation of short sample clips of the music content for free. However, to listen to the complete music track, the user will have to complete an e-commerce transaction.

In addition to using the multimodal inputs to provide e-commerce enabled information services, information services may also inherently rely on the multimodal inputs to initiate e-commerce transactions. An example is where the visual imagery of a credit card is used to obtain the credit card information and charge an e-commerce transaction to the credit card account.

In some embodiments, visual and other multimodal inputs may be used by the system 100 to provide security features such as authentication and authorization.

In an exemplary information service, visual imagery of a physical token is used to authenticate the veracity of the physical token. The physical token may be in the form of a printed paper ticket, visual information printed on objects such as a shirt or identification badge, or visual information displayed on an electronic display such as a LCD screen.

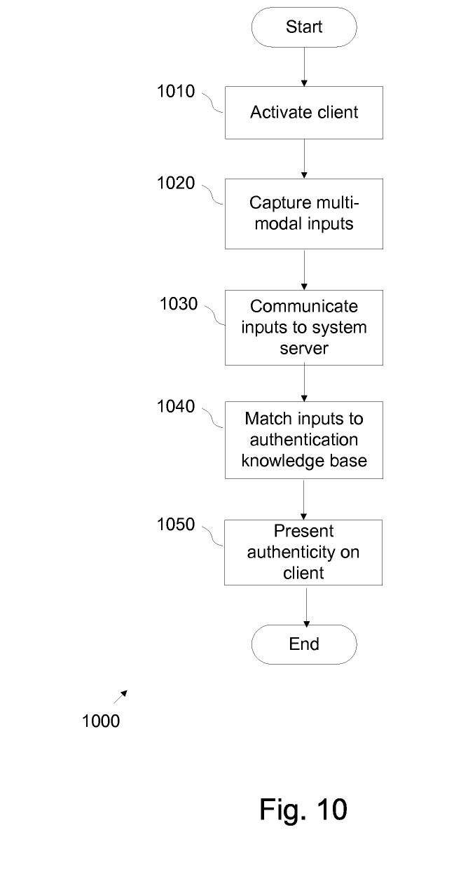

FIG. 10 illustrates the exemplary sequence of operations for process 1000 of using an information service for authentication of an identification badge. The user activates the badge authentication information service 1010. The user then captures a still image of the identification badge using the client 1020. The badge authentication information service automatically encodes and communicates the image and associated metadata to the system server 1030. The system server extracts key authenticable information from the still image and matches it against a knowledge base of identification badge information 1040. The authenticity of the badge is then communicated back to the client and displayed on the client user interface 1050.

In one embodiment, the authenticity of the physical token may be used to authorize access to various assets in the real and virtual worlds. For example, the physical token may be a movie ticket whose veracity is authenticated and used to authorize entry into a movie theatre. Alternatively, the physical token may be an identification badge that permits entry into a building or premises. Besides access to physical entities, the physical token may also be used to authenticate and authorize access to virtual world or cyber world entities such as games.

Integrating this capacity to authenticate a physical token with an accounting system, an information service may provide a means of using the physical token as currency. An example usage scenario is the charging of a fixed value to a user's billing account every time the user uses such an information service to capture visual imagery of the physical token.

In some embodiments, the information services may enable users to author new information or content and associate them with contexts. Such content may be in one or more multimedia formats such as audio, video, textual, or graphical formats.

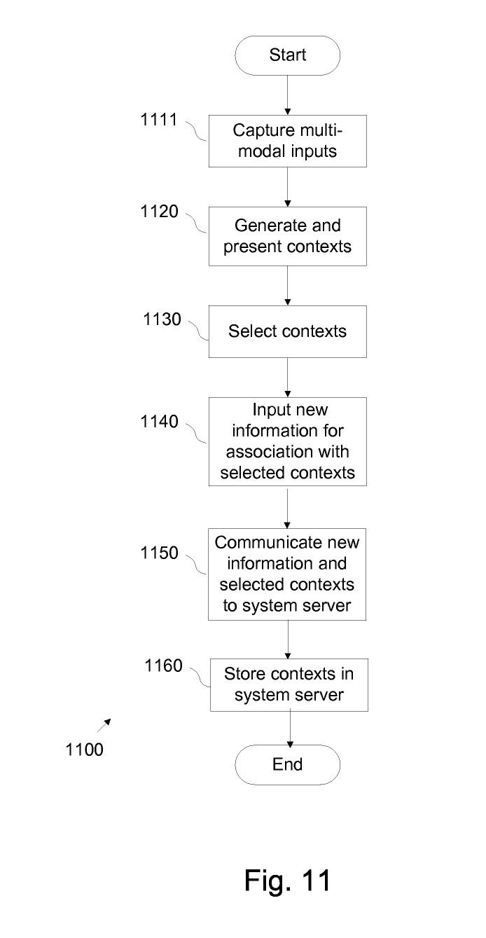

FIG. 11 illustrates an exemplary sequence of operations for process 1100 of using an information service to associate new information with a context. The user captures visual information and other multimodal inputs using the client 1110. System 100 generates contexts from the inputs which are presented to the user 1120. Alternately, the user may define a context from the multimodal inputs through explicit manual specification of context constituents using appropriate controls provided by the system user interface. The user then selects one or more of the generated contexts 1130. He then inputs a text string or other content such as audio or video to be associated with the selected contexts 1140.

The newly authored content that is associated with the contexts may be sourced either (1) live through sensors integrated into the system such as a camera, microphone or keypad or (2) from storage containing prerecorded content. The selected contexts and user input content are then communicated to the system server 1150. The newly authored content is then added to one of the internal knowledge bases of the system 1160. This user-authored content may be provided to the users of the system as appropriate information services for consumption when the users (not necessarily the author) use the system to obtain information services relevant to contexts similar to the context with which the newly authored content is associated. Thus, users can attach multimedia content to contexts that can then be accessed using multimodal inputs.

While the foregoing focuses on multimedia content authored by the users of the system, users can also author complete information services that incorporate multimedia content, the user interface for manipulating and presenting the multimedia content and the logic that orchestrates the user interface and processing of the multimedia content.

The author of a newly created content or information service may or may not wish to share the content or information service with other users of the system. Hence, the system may enable the author to restrict access to the newly created content or information service based on various criteria such as individual users, user groups, time, location, specific information services, etc. The author may specify such access restrictions either at the time of authoring the information or later. In addition, the newly authored content or information service may also have access restrictions imposed on it by the operators of the system to protect the privacy, safety, and rights of the users of the system.

In addition to specifying access restrictions on the newly authored content and information services, the author may also specify associated financial transactions to create sponsored or commercial information services. In one embodiment, the financial transactions envelope the entire content or information service such that the financial transaction has to be completed to access the content or information service.

In another embodiment, the financial transactions envelope only part of the content or information service such that the “free” part of the content or information service is accessed without executing any financial transactions while the “restricted” part is accessed only after completing the financial transactions. For instance, a portion of a video sequence may be available for consumption for free while users will have to pay to play the complete video sequence.

The exemplary authoring information service in the discussion above, focused on the creation of new content or information service. However, existing content and information services associated with a context may also be edited by users of the system. The feature of editing the content and information services may be embedded in various information services. Similarly, any access restriction and e-commerce features embedded in the information services may also be edited by the author.

Moreover, such editing functionality is optionally also provided to multiple users of the system effectively creating multiauthor content and information services. The enumeration of the users that have rights to edit the content and information services is specified either by the users that already have such rights or by the operators of the system or a combination of both.

Such authoring and editing of the information services may be performed by users at the time of capture of the context from the real world environment using a client device or at a later time. Authoring and editing of the information services from captured content stored in the system or content accessible to the system from external stores such as the World Wide Web may also be performed.

In some embodiments, authoring and editing may be enabled through a full-featured environment such as a web browser or software application installed on a personal computer that interfaces with the system. For instance, a user may highlight a word on the web browser and associate the word with various content or information services using menu options or a toolbar integrated into the web browser.

Information services provided by the system may be inherently accessible only using contexts generated from multimodal inputs with which they are associated. However, users may wish to access information services that they obtained using a specific context at a later time when they no longer have access to the context. Such extended access to the information services may be enabled by providing users the option to save contexts and associated information services in the system for later retrieval.

For example, a user obtains information relevant to the title of a book such as its description and price and store the context constituted by the image of the book, its title, and the associated information (e.g., the book description and price) for later retrieval. At a later time, the user retrieves the stored information for further reference or to access other features of the information service such as the purchase of the book through e-commerce even though he may no longer have access to the book originally used to generate the context.

Contexts and associated information services may be stored on a server on a network or on a user's personal computer or other computing/communication equipment. The stored contexts and associated information services are accessed either from the equipment initially used to access the information services or from a secondary user interface such as a PC-based web browser, for example. At the time of retrieval, the contexts and associated information services may be used to present an augmented version of the multimodal input information retrieved from storage as if the multimodal input information were being input live from the client.

In addition, the stored contexts and associated information services may be searched by context, time, author, etc. and presented sorted by parameters such as time of capture of the visual imagery, time of access to the associated information services, popularity of information services accessed by the user, duration of access to information services by the user or a plurality of such parameters. The stored contexts and associated information services can also be shared or communicated with others through use of standard communication technologies like e-mail, SMS, MMS, instant messaging, facsimile, circuit switched channels or other proprietary formats and protocols.

The storage of content related to contexts generated from visual imagery enables storage of digital representations of the information captured as visual imagery, when such digital representations are available. For instance, when a specific content is available both in printed form and in electronic form on the World Wide Web, the electronic form may be retrieved using visual imagery of the printed form of the content. The retrieved electronic form may then optionally be stored in the system.

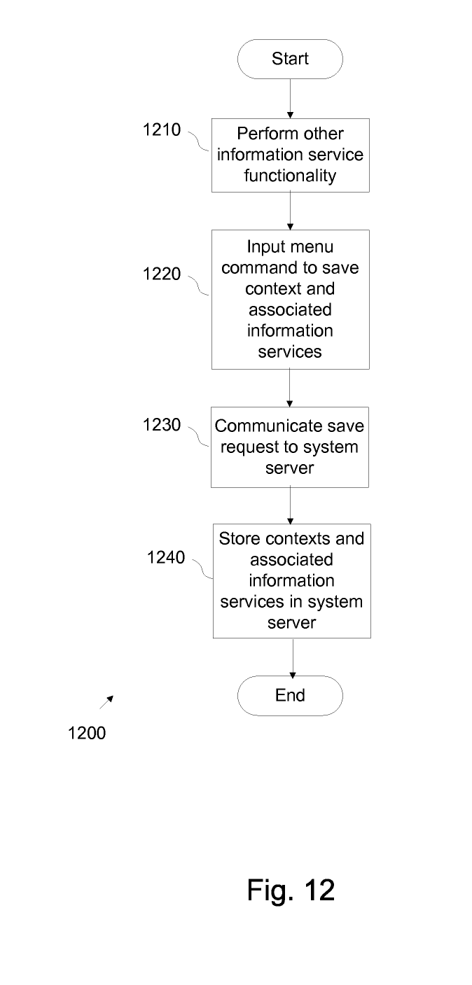

FIG. 12 illustrates an exemplary sequence of operations for process 1200 of using the storage features of an information service. A user of a storage enabled information service uses the information service to perform other functionality such as relevant information access or e-commerce 1210. After using the other functionalities, the user chooses a menu command in the user interface to save the context used to access the information service and all associated information services 1220.

Alternately, the user may choose a menu command to save just a selected information service. In some embodiments, this command and the identification of the context or the information service to be saved are communicated to the system server by the client 1230. The system server then saves the context and associated information services in the system 1240. In some embodiments, the context and associated information services are stored on the client device.

When the user wishes to access the saved context and associated information services, at a later time, he may access all such information services saved by him using a personal computer based web browser or the client device. The stored context and associated information services are then used to augment the multimodal input information retrieved from storage and present a user experience similar to the augmentation of multimodal input information captured from the real world environment.

Embodiments of information services and information provided by information services may also be communicated through communication channels such as e-mail, instant messaging, SMS, MMS, GPRS, circuit switched channels or proprietary formats and protocols. This enables users of the system to share information services with others who may or may not have access to the information services. For instance, a user can look up the price of a book based on the context provided by its title and then e-mail the information to a friend. The recipient of the communication may not necessarily be part of the system or a user of the system. Voice calls are also a type of information service and may also be embedded as part of more complex information services.

The system optionally incorporates a list of friends or groups to which the user belongs. Such a list enables the quick selection of friends and groups with whom the user can share information services. When the system provides such a list of friends and groups feature, the system also includes tools to manage the lists e.g., to add and delete entries in the lists.

The communicated information service may be presented asynchronously as soon as it is received, e.g. in a push model of delivery. This enables users to share information services with friends and user groups instantaneously. Such an asynchronous delivery is signaled to the recipient through an audio or visual cue on their client device.

Besides the sharing of content and information services with other users of the system through explicit specification by the user, the system also automatically updates groups of users with content and information services authored by members of the group. For instance, when a user of the system that belongs to a group of users or ‘friends’ authors a new content or information service, all other members of the group are notified about the creation of the new content or information service through an audio or visual signal on their client device. In one embodiment, the communicated content or information services are presented only when the recipient chooses to view or consume such communication, e.g., in a pull model.

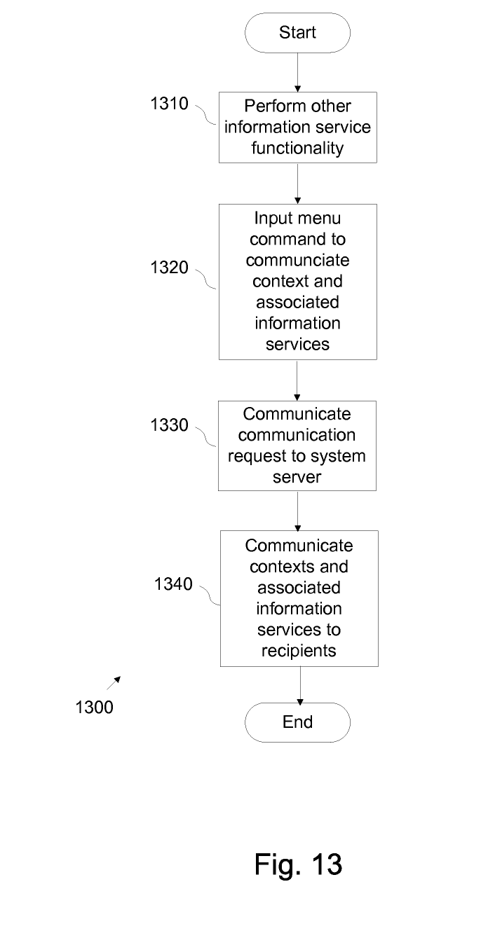

FIG. 13 illustrates an exemplary sequence of operations for process 1300 of using an information service to communicate contexts and associated information services. A user of a communication enabled information service uses the information service to perform other functionality such as relevant information retrieval and e-commerce 1310. After using the other functionalities, the user chooses a menu command in the user interface to specify a means of communicating the context used to access the information service and all associated information services to one or more recipients 1320.

Alternately, the user may choose a menu command to communicate just a selected information service. The command, the list of recipients of the communication, the specified communication channel and the identification of the context or the information service to be communicated is transmitted to the system server by the client 1330. The system server then communicates the context and associated information services to the recipients using the communication channel specified by the user 1340. In some embodiments, the client communicates the context and associated information services directly to the recipients using communication functionality built into the client device without the intermediation of the system server.

The capability for communicating information services built in the system in some embodiments enables users to simultaneously share information services available to them. For instance, a user of the system accesses an information service providing the description and price information of a book based on the context provided by the title of a book and invites one or more of his friends or user groups to view or consume the information service.

Then, all interested recipients of the invitation can choose to browse the information service simultaneously in synchrony with the first user. Such a function is especially useful since the information services are provided based on a real world context that may not necessarily be available to all users. Thus, this feature enables users of the system to share the context used to present relevant information resulting in a shared user experience, i.e., provides a virtual context to users of the system who do not have access to the real context.

The shared user experience may be implemented at various resolutions: (1) just the context is shared and the individual users use the associated information services independently, (2) the context and the particular information service being used is common to all the users participating in the shared experience with each user controlling his own interaction with the information service, or (3) one user selects a context, an associated information service and interacts with the information service, while all the other users participating in the shared experience are presented the user experience of the first user in synchrony. In scenario (3), only one of the users can interact with the information service while the other users act as spectators.

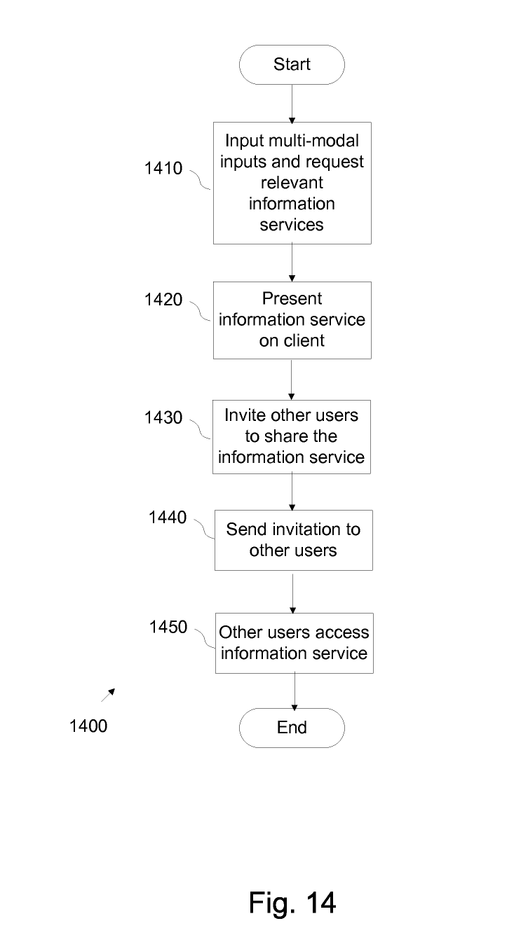

FIG. 14 illustrates an exemplary sequence of operations for process 1400 of sharing an information service among two users of the system. For example, a user in Times Square in New York points the camera integrated into the client device at the scrolling NASDAQ display and requests associated information services 1410. The system provides an information service that enables him to lookup financial information on the stock symbols presently shown on the display 1420.

The user then invites a set of friends (i.e., other users of the system) to share the information service with him by selecting the appropriate menu command 1430. The friends receive the invitation in the form of an audible or visible alert and launch the client on their client devices 1440. The user's friends are then able to watch the information service being presented to the user and the associated context as if they were present with the user at Times Square 1450.

In some embodiments, an information service includes entertainment features. An entertainment information service involves contexts from the real world environment in an entertainment scenario where elements such as a TV, computer, or Cinema screen may form part of the context.

For instance, a phone number or text from the visual imagery of a video on a television screen may be extracted and used to provide an interactive television viewing experience. Besides relying on the embedded data in the environment such as the text from television programming, additional cues may also be explicitly added to the environment for enhanced functionality.

For instance, the television programming may include embedded visual and audio cues specially designed to trigger appropriate information services in the system. Examples of features of such entertainment information services include dialing a phone number displayed in the television programming, displaying a web page whose URL is displayed in the television programming or casting the ballot in a televised voting program such as “American Idol.”

Another potential type of information service incorporating entertainment features is a game that exploits the contexts generated from real world environments. An example is a clue following game where users follow a clue trail of contexts from the real world environment such as text from signboards.

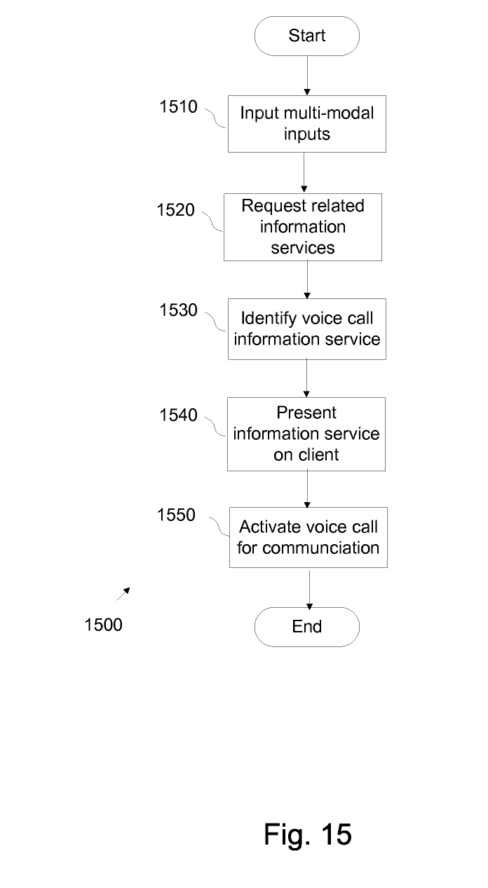

FIG. 15 illustrates an exemplary sequence of operations for process 1500 of using an entertainment information service. A user using the entertainment information service captures visual imagery of the video being displayed on a television screen 1510. The visual imagery is encoded and communicated to the system server where the visual imagery is analyzed to extract embedded data and identify relevant entertainment information services 1520.

For instance, telephone numbers embedded in the visual imagery is extracted and used to generate an entertainment information service that enables calling the telephone number 1530. The user is then presented the entertainment information service that on the client 1540. To call the telephone number displayed on the television screen, the user activates the voice call link in the information service and the system establishes a voice call between the user's client device and the identified phone number using voice over IP (VoIP) or circuit switching 1550.

In another entertainment information service, the user captures visual imagery with the camera embedded in the client device of a competition presented on television. The client encodes the captured visual imagery and communicates it to the system server along with associated metadata such as the time of the day and geographic location. Based on the time of the day when the live television programming is being broadcast, geographic location of the client device and the visual cues present in the visual imagery, the entertainment information service logic in the system server identifies the visual imagery as that of the competition and generates an appropriate information service in the form of a user voting form.

The generated information service is presented in the content view of the client where the user votes on his choice in the competition. The user's choice is communicated back to the system server, aggregated with votes from other users of the information service and communicated to the producers of the competition television show. Thus, this information service enables users to vote on a live competition television show.

Another exemplary entertainment information service is a game based on the interaction of users of the invention with their real world environments. Users of the game information service receive a specific “prize word” every day through communication channels such as e-mail or SMS. Users then capture visual imagery of the word from their real world environments using the camera built into the client device. The visual imagery is encoded and communicated to the system server.

The system server component of the game information service analyzes the visual imagery and extracts the embedded textual information to verify the presence of the prize word. If the prize word is present in the visual imagery, then the user's score is incremented. At the end of the day, the user with the greatest score is awarded a prize. While this is a very rudimentary game information service built using the system infrastructure other more complex game information services can be built using the same principles.

In some embodiments, the system may store a historical record of contexts and information services used by a user. This enables a user to potentially augment or extend his personal memory by recalling past usage of the system. Such historical content and information services includes contexts and information services that the user stored by using the system and optionally other content and information services obtained and stored by other means such as user's photos, e-mails etc. This historical content and information services can be stored on the user's personal computer or on a remote server.

When a user captures a multimodal input and requests information services, information services from his historical database may also be searched for matching information services. As in other information services offered by the system, the system ranks and generates the most relevant information services using criteria such as the user's usage history of the system, the information services and the relationships between the information services. For instance, the amount of time a user consumes a specific information service may be used as a measure of the user's interest level in the information service.

The personal memory augmentation information service may be optionally accessed from a full featured environment such as a personal computer based web browser. The user logs into his account on the personal memory augmentation information service web site and is presented a list of all contexts generated by him and the associated information services. The user uses the various search, sorting, and filtering options in the web site user interface to manage his history of usage of the system.

In addition, the user can communicate the content available to him through the personal memory augmentation information service using communication channels such as e-mail, SMS, or shared web access. The historical record of a user's use of the system may also system may also used to drive other information and physical systems such as sponsored information service marketplaces or a user loyalty program.

Embodiments of information services may also be tailored to requirements specific to a particular industry or use case scenario. Examples of such services include:

A newspaper or book publisher may author content to be delivered through the system along with the print version of the publication. Such content may be automatically delivered through the invention when a user uses the invention in conjunction with the publication.

An exemplary information service designed to work with publications like newspapers and magazines enables users to capture visual imagery of articles or portions of articles in the publications (e.g. the headlines, titles, or partial headlines or titles) and provides relevant features. Typical features of such an information service may include providing updates to the articles, saving the captured visual imagery of the articles, saving a digital version of the articles obtained from appropriate content sources, providing multimedia information (e.g., video, podcasts) relevant to the articles and communicating and sharing of the articles.

A related example involves the producer of a television show producing content to be delivered through the system along with the television content itself. When the show is aired users of the system are able to access the system-specific content through the system, when they use the system on contexts incorporating the television show.

Another example of an industry specific solution is an information service that automatically recognizes visual imagery of transaction receipts and stores the information in spreadsheet format or updates an online expense management system. This enables business travelers to capture receipts and automatically generate an expense report.

In some embodiments, components of information services may be integrated with other information services external to the system. For instance, the content from an information service may be integrated into a web log (blog), website or RSS feed.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

1.-17. (canceled)

18. A method comprising:
receiving, at a server, content from a user device;
generating one or more contexts based on the received content;
sending the one or more contexts to the user device;
receiving second content and a selected context from the one or more contexts from the user device;
associating the second content with the selected context; and
storing the associated second content.

19. The method of claim 18, further comprising:
receiving a request to restrict access to the second content.

20. The method of claim 18, further comprising:
receiving a request from the user device to edit the stored second content; and
storing the edited second content.

21. The method of claim 18, further comprising:
receiving a request from a second user device to edit the stored second content, and
storing the edited second content.

22. The method of claim 18, further comprising:
querying an information service using the one or more contexts;
generating search results based on the querying; and
sending the search results to the user device.

23. The method of claim 18, wherein the content and the second content each comprises one or more of audio, visual information, or text.

24. A method comprising:
sending content from a user device to a server;
receiving one or more contexts based on the content;
selecting a context from the one or more contexts;
sending the selected context to the server; and
sending second content associated with the selected context to the server.

25. The method of claim 24, further comprising:
sending a request to the server to restrict access to the second content.

26. The method of claim 24, further comprising:
sending a request to edit the stored second content; and
receiving the edited second content.

27. The method of claim 24, further comprising:
receiving, from the server, search results based on the selected context.

28. The method of claim 24, wherein the content and the second content each comprises one or more of audio, visual information, or text.

29. The method of claim 28, further comprising:
capturing the content with the user device.

30. A user device comprising:
a communication interface to sending content from the user device to a server and to receive one or more contexts based on the content;
logic to select a context from the one or more contexts;
wherein the communication interface is to further send the selected context and second content associated with the selected context to the server.

31. The user device of claim 30, where
The communication interface is to further send a request to the server to restrict access to the second content.

32. The user device of claim 30, wherein:
the user interface is to further send a request to edit the stored second content, and receive the edited second content.

33. The user device of claim 30, wherein:
the user interface is to further receive, from the server, search results based on the selected context.

34. The user device of claim 30, wherein the content and the second content each comprises one or more of audio, visual information, or text.

35. The user device of claim 30, further comprising:
a user input device to capture the content.

36. The user device of claim 35, wherein the user input device comprises one or more of: a camera, a microphone, a keypad, and a touch sensor.
